(19) United States
(12) Patent Application Publication
(10) Pub. No.: US 2017/0217754 A1
(43) Pub. Date: Aug. 3, 2017

(54) FILLING ADAPTER (MAINTENANCE CHECK)

(71) Applicant: DÜRR SOMAC GmbH, Stollberg (DE)

(72) Inventors: Thomas ACHATZ, Niederdorf (DE); Eric SELBMANN, Gersdorf (DE); Frank WIELAND, Burkhardtsdorf (DE); André GRIMM, Treuen (DE)

(73) Assignee: DÜRR SOMAC GmbH, Stollberg (DE)

(21) Appl. No.: 15/129,993

(22) PCT Filed: Mar. 18, 2015
(86) PCT No.: PCT/DE2015/000141

§ 371 Date: Sep. 28, 2016

(30) Foreign Application Priority Data
Mar. 29, 2014 (DE) 10 2014 004 822.5

(51) Int. Cl. B67D 7/32; B67D 7/22; G08B 21/18; B67D 7/42

(52) U.S. Cl. CPC B67D 7/32; B67D 7/425; B67D 7/22; G08B 21/18

(57) ABSTRACT

A filling adapter for a container to be filled with media, in particular for the filling of containers on assembly lines for the production of motor vehicles where the filling adapter is equipped with a hose pack, electrical, pneumatic, and hydraulic lines. An electronic assembly (ID chip) for a maintenance check is integrated in the adapter head of the filling adapter, which assembly detects the number of use cycles of the filling adapter and compares said number with parameters which can be set in advance in such a way that when said parameters are approached, at least one prior warning is triggered, and when said parameters are reached, an associated controller is informed about the maintenance which is now due.

### CROSS-REFERENCE TO RELATED APPLICATIONS

This application is a National Stage of International Application No. PCT/DE2015/000141, filed Mar. 18, 2015, claiming benefit to DESN 102014004822.5, filed Mar. 29, 2014. The entire disclosures of each of the above applications are incorporated herein by reference.

### FIELD

The present disclosure relates to a filling adapter for a container to be filled with media (e.g. oils, gases, coolants and the like), in particular for the initial filling of containers with operating substances on assembly lines for the production of motor vehicles, wherein the filling adapter is equipped with a hose pack, electrical, pneumatic and hydraulic lines.

### BACKGROUND

This section provides background information related to the present disclosure which is not necessarily prior art.

Containers must be filled with liquids or gases for numerous technical applications. A typical application in this respect are motor vehicles where housings, circuits, equalizing reservoirs and the like have to be filled with fuel, lubricants, coolants, and other operating substances. In the manufacturing process, these vehicles must be filled, for example, with brake fluid, power steering fluid, coolant, refrigerant, windshield wiper fluid, and fuel. These media are fed via hoses and special adapters to the respective circuits of the vehicles. The hoses typically include multiple lines with different functions for vacuum application, back suction, filling, aerating, as well as for electrical cables.

To perform the filling, a worker has to bring the adapter and hose pack to the vehicle depending on the respective position of the filling station and connect it to the ports of the circuits to be filled.

These assemblies must undergo periodic maintenance to ensure that the filling adapter is functional. It is preferably performed at defined cycles, which can be related, for example, to continually recurring periods or to utilization periods. However, keeping track of these cycles depends on the thoroughness of the maintenance operations (customer). It cannot be excluded that maintenance intervals are not exactly complied with. Such risk is particularly considerable if the filling adapter is not exclusively used with the same filling station but at various filling stations. For maintenance cycles based on time, it is also questionable if the filling adapter really has been used frequently enough that maintenance is required. For maintenance cycles based on use, multiple filling adapters may be needing maintenance within a short time interval. If these maintenance operations are not performed, there can be unforeseen failures of the filling adapters on the assembly line, which in extreme cases can result in a temporary shutdown of the assembly line.

### SUMMARY

This section provides a general summary of the disclosure, and is not a comprehensive disclosure of its full scope or all of its features.

The purpose of this disclosure is to create a technical solution with which the need for maintenance of such a filling adapter is detected and reported promptly and independently of care and expertise of the maintenance team (customer).

This problem is solved with an integrated electronic assembly (ID chip) for a maintenance checks in the head of the filling adapter. So the assembly detects the number of use cycles of the filling adapter and compares said number with parameters which can be set in advance. When said parameters are approached, at least one prior warning is triggered, and when said parameters are reached, an associated controller is informed about the maintenance which is now due.

The prior warning gives a worker a first indication that the filling adapter will soon have to undergo maintenance. Where such a prior warning is transmitted to a control center, e.g. to production management, the worker is relieved and the functioning of the entire filling station can be improved, since this control center can prepare the switchover without impairing the worker's job. This variant s advantageous from a manufacturing point of view, since the filling adapter to undergo maintenance can be replaced with another filling adapter in the rest cycle between two filling cycles.

Furthermore, the adapter head is configured with an electronic interface via which a special software provides information about performed maintenance operations and can switch the electronic assembly (ID chip) to a new initial state for recording the number of utilization cycles of the filling adapter for maintenance monitoring.

This technical solution detects the need for maintenance of a filling adapter regardless of the care and expertise of a worker and indicates it at an early point in time. This permits planned maintenance and reduces unexpected incidents in the production process, e.g. simultaneous replacement of multiple filling adapters. Another advantage is protection from manipulation, since the ID chip documents the actual use conditions. This means that the filling adapter can be used at various filling stations without disadvantages with respect to maintenance.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a cross-view of the disclosure.

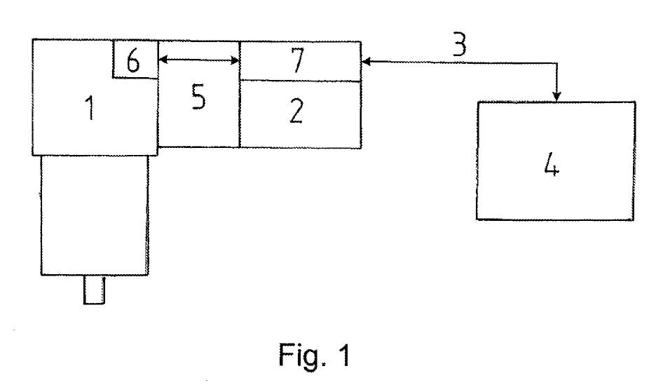

Corresponding reference numerals indicate corresponding parts throughout the several views of the drawings.

### DETAILED DESCRIPTION

Example embodiments will now be described more fully with reference to the accompanying drawing.

The figure shows an embodiment of the disclosure. It shows the fundamental design of a filling adapter having an adapter head 1, a terminal housing 2 for a hose pack 3, and a station controller 4. An electronic assembly 6 that is in an operative connection with the station controller via an electronic adapter circuit 7 is integrated in the adapter head 1 for maintenance checking. The electronic assembly 6, preferably an ID chip, detects the number of use cycles of the filling adapter and compares said number with parameters which can be set in advance in such a way that when said parameters are approached, at least one prior warning is triggered, and when said parameters are reached, an associated controller 4 is informed about the maintenance which is now due.

Furthermore, an electronic interface 5 is configured on the adapter head 1. This interface 5 uses a special software to provide information about performed maintenance operations and can switch the electronic assembly/ID chip 6 to a new initial state for recording the number of utilization cycles of the filling adapter for maintenance monitoring.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A filling adapter for a container to be filled with media, in particular for the initial filling of containers with operating substances on assembly lines for the production of motor vehicles, wherein the filling adapter is equipped with a hose pack, electrical, pneumatic and hydraulic lines, wherein
an electronic assembly is integrated in the adapter head of the filling adapter for
maintenance check, which detects the number of use cycles of the filling adapter and compares said number with parameters which can be set in advance in such a way that when said parameters are approached, at least one prior warning is triggered, and when said parameters are reached, an associated controller is informed about the maintenance which is now due.

2. The filling adapter according to claim 1, wherein
the prior warning is transmitted directly to the worker at the filling station and/or to a control center.

3. The filling adapter according to claim 1, wherein
the adapter head is configured with an electronic interface via which a special software provides information about performed maintenance operations and can switch the electronic assembly to a new initial state for recording the number of utilization cycles of the filling adapter for maintenance monitoring.
